(19) United States
(12) Patent Application Publication
(10) Pub. No.: US 2026/0259435 A1
(43) Pub. Date: Sep. 3, 2026

(54) Heatable Photochromic Optical Article and Method of Making the Same

(71) Applicant: Transitions Optical, Ltd., Tuam (IE)

(72) Inventors: Eric Carlson, Pittsburgh, PA (US); Brian Smyth, Tuam (IE); Brad S. Veldkamp, Grand Rapids, MI (US); Anil Kumar, Murrysville, PA (US); Michael Pollin, Ambridge, PA (US)

(21) Appl. No.: 19/162,471

(22) PCT Filed: Mar. 7, 2023
(86) PCT No.: PCT/EP2023/055649

§ 371 Date: Sep. 5, 2025

(51) Int. Cl. G02F 1/01; C08J 7/04; C09D 5/00; C09D 5/24; C09D 5/26; C09D 5/29; C09D 7/40; C09D 7/61; C09D 125/18; C09D 165/00; G02B 5/23

(52) U.S. Cl. CPC G02F 1/0147; C08J 7/0423; C09D 5/002; C09D 5/24; C09D 5/26; C09D 5/29; C09D 7/61; C09D 7/70; C09D 125/18; C09D 165/00; G02B 5/23; C08J 2369/00; C08J 2425/18; C08J 2465/00

(57) ABSTRACT

A heatable optical article is provided. The heatable optical article includes: an optical substrate comprising a first surface and a second surface opposite the first surface; an electrode located over at least a portion of the first surface, wherein the electrode includes an electrically conductive three-dimensional network; a photochromic coating comprising at least one photochromic material; and a power supply electrically connected to the electrode. A method of making the heatable optical article is also provided.

### BACKGROUND OF THE INVENTION

### Field of the Invention

The present invention relates to heatable optical articles and a method of making heatable optical articles. In particular, the present invention relates to heatable optical articles having an optical substrate, an electrode having an electrically conductive three-dimensional network located over at least a portion of the optical substrate, a photochromic coating comprising at least one photochromic material, and a power supply electrically connected to the electrode.

### Description of Related Art

In response to certain wavelengths of electromagnetic radiation (e.g., actinic radiation), photochromic compounds typically undergo a transformation from one form or state to another form, with each form having a characteristic or distinguishable absorption spectrum associated therewith. Typically, upon exposure to actinic radiation, many photochromic compounds transform from a closed-form, which corresponds to an unactivated or bleached state (e.g., substantially colorless) to an open-form, which corresponds to an activated or colored state. When the actinic radiation is removed, the photochromic compounds may reversibly transform from the activated or colored state back to the unactivated or bleached state. A “thermally reversible photochromic compound” is a photochromic compound that converts from an unactivated or bleached state to an activated or colored state in response to actinic radiation, and reverts back to the unactivated or bleached state in response to thermal energy.

Compositions and articles, such as eyewear lenses, that contain photochromic materials or have photochromic materials applied thereto, such as in the form of a photochromic coating composition, typically display colorless (or clear) and colored states that correspond to the colorless and colored states of the photochromic materials contained therein and/or applied thereto.

However, the fade speed from the activated or colored state to the unactivated or colorless state can depend upon the ambient temperature. For example, the switching time of the photochromic material from the activated or colored state to the unactivated or colorless state in cold temperatures can be slow. It would be desirable to develop an article that could heat a photochromic coating to improve the fade speed of photochromic materials within the photochromic coating.

### SUMMARY OF THE INVENTION

In some non-limiting examples or aspects of the present disclosure, provided is a heatable optical article. The optical article includes: an optical substrate including a first surface and a second surface opposite the first surface, an electrode located over at least a portion of the first surface, wherein the electrode includes an electrically conductive three-dimensional network, a photochromic coating including at least one photochromic material, and a power supply electrically connected to the electrode.

In some non-limiting examples or aspects of the present disclosure, provided is a method of making a heatable optical article. The method includes: applying an electrode over at least a portion of a first surface of an optical substrate, wherein applying the electrode includes applying a dispersion comprising an electrically conductive material, and fusing the electrically conductive material to form an electrically conductive three-dimensional network; applying a photochromic coating including at least one photochromic material; and connecting a power supply to the electrode.

A heatable optical article and a method of making a heatable optical article may be characterized by one or more of the following aspects.

In a first aspect, a heatable optical article, includes: an optical substrate including a first surface and a second surface opposite the first surface; an electrode located over at least a portion of the first surface, wherein the electrode includes an electrically conductive three-dimensional network; a photochromic coating including at least one photochromic material; and a power supply electrically connected to the electrode.

In a second aspect, in the heatable optical article in accordance with the first aspect, the photochromic coating is located over at least a portion of the first surface and the electrode is located over the photochromic coating; or the electrode is located over at least a portion of the first surface and the photochromic coating is located over the electrode.

In a third aspect, in the heatable optical article in accordance with the first aspect or second aspect, further including one or more bus bars or electrical leads in electrical contact with the electrode, the one or more bus bars or electrical leads are electrically connected to the power supply.

In a fourth aspect, in the heatable optical article in accordance with any one of the first aspect to the third aspect, the electrically conductive three-dimensional network includes an electrically conductive material including conductive nanowires.

In a fifth aspect, in the heatable optical article in accordance with the fourth aspect, the conductive nanowires are selected from the group consisting of silver nanowires, nickel nanowires, copper nanowires, and combinations of two or more thereof.

In a sixth aspect, in the heatable optical article in accordance with the fifth aspect, the conductive nanowires include silver nanowires.

In a seventh aspect, in the heatable optical article in accordance with any one of the first aspect to the sixth aspect, the electrode further includes an electrically conductive encapsulating layer adjacent to the electrically conductive three-dimensional network.

In an eighth aspect, in the heatable optical article in accordance with the seventh aspect, the electrically conductive encapsulating layer includes an electrically conductive encapsulating material selected from the group consisting of a conductive polymer and a doped metal oxide.

In a ninth aspect, in the heatable optical article in accordance with the eighth aspect, the conductive polymer includes poly(3,4-ethylenedioxythiophene) polystyrene sulfonate (PEDOT:PSS).

In a tenth aspect, in the heatable optical article in accordance with the eighth aspect, the electrically conductive encapsulating material includes a doped metal oxide selected from aluminum doped zinc oxide or indium doped tin oxide.

In an eleventh aspect, in the heatable optical article in accordance with any one of the first aspect to the tenth aspect, further including an adhesive layer located over at least a portion of the first surface, wherein the electrode is located over the adhesive layer, and wherein the adhesive layer includes an adhesive selected from the group consisting of polyvinyl butyral, poly(meth)acrylates, hydroxyl-functional poly(meth)acrylates, and combinations thereof.

In a twelfth aspect, in the heatable optical article in accordance with any one of the first aspect to the eleventh aspect, further including one or more coating layers, wherein the one or more coating layers preferably are selected from the group consisting of an alignment layer, a primer layer, a hard coat layer, and a barrier layer.

In a thirteenth aspect, in the heatable optical article in accordance with any one of the first aspect to the twelfth aspect, the electrode has a sheet resistance of less than 60 Ohms per square (Ω/□).

In a fourteenth aspect, in the heatable optical article in accordance with any one of the first aspect to the thirteenth aspect, the optical article has a visible light transmittance of at least 75% as measured by a spectrophotometer, such as a UltraScan Pro (HunterLab).

In a fifteenth aspect, in the heatable optical article in accordance with any one of the first aspect to the fourteenth aspect, the substrate includes a polymeric material selected from the group consisting of polycarbonate, polycyclic alkene, polyurethane, poly(urea)urethane, polythiourethane, polythio(urea)urethane, polyol(allyl carbonate), cellulose acetate, cellulose diacetate, cellulose triacetate, cellulose acetate propionate, cellulose acetate butyrate, poly(vinyl acetate), poly(vinyl alcohol), poly(vinyl chloride), poly(vinylidene chloride), poly(ethylene terephthalate), polyester, polysulfone, polyolefin, polyether, polyamide, polyalkyl (meth)acrylate, polyvinyl butyral, polystyrene, copolymers of two or more thereof, and mixtures of two or more thereof.

In a sixteenth aspect, in the heatable optical article in accordance with any one of the first aspect to the fifteenth aspect, the article is an optical element selected from the group consisting of ophthalmic articles, display articles, windows, and mirrors, preferably the ophthalmic article is selected from the group consisting of corrective lenses, non-corrective lenses, contact lenses, and protective lenses.

In a seventeenth aspect, a method of making a heatable optical article includes: applying an electrode over at least a portion of a first surface of an optical substrate, wherein applying the electrode includes: applying a dispersion comprising an electrically conductive material, and sintering the electrically conductive material to form an electrically conductive three-dimensional network; applying a photochromic coating including at least one photochromic material; and connecting a power supply to the electrode.

In an eighteenth aspect, in the method of making a heatable optical article in accordance with the seventeenth aspect, including: applying the photochromic coating over at least a portion of the first surface and applying the electrode over the photochromic coating; or applying the electrode over at least a portion of the first surface and applying the photochromic coating over the electrode.

In a nineteenth aspect, in the method of making a heatable optical article in accordance with the seventeenth aspect or the eighteenth aspect, further including: applying from 2 to 9 layers of the dispersion including the electrically conductive material; and sintering each electrically conductive material layer individually to form the electrically conductive three-dimensional network, or sintering the 2 to 9 electrically conductive material layers simultaneously to form the electrically conductive three-dimensional network.

In a twentieth aspect, in the method of making a heatable optical article in accordance with any one of the seventeenth aspect to the nineteenth aspect, the electrically conductive material includes conductive nanowires.

In a twenty-first aspect, in the method of making a heatable optical article in accordance with the twentieth aspect, the conductive nanowires are selected from the group consisting of silver nanowires, nickel nanowires, copper nanowires, and combinations of two or more thereof.

In a twenty-second aspect, in the method of making a heatable optical article in accordance with the twenty-first aspect, the conductive nanowires include silver nanowires.

In a twenty-third aspect, in the method of making a heatable optical article in accordance with any one of the seventeenth aspect to the twentieth aspect, the electrically conductive material is sintered using electromagnetic radiation.

In the twenty-fourth aspect, in the method of making a heatable optical article in accordance with any one of the seventeenth aspect to the twenty-third aspect, applying the electrode further includes: applying an electrically conductive encapsulating material adjacent to the electrically conductive three-dimensional network to form an electrically conductive encapsulating layer.

In the twenty-fifth aspect, in the method of making a heatable optical article in accordance with the twenty-fourth aspect, the electrically conductive encapsulating material is selected from the group consisting of a conductive polymer and a doped metal oxide.

In the twenty-sixth aspect, in the method of making a heatable optical article in accordance with any one of the seventeenth aspect to the twenty-fifth aspect, at least one of the electrically conductive material, the electrically conductive encapsulating material, or the photochromic coating is applied by spin coating.

In the twenty-seventh aspect, in the method of making a heatable optical article in accordance with any one of the seventeenth aspect to the twenty-sixth aspect, further including applying one or more coating layers, wherein the one or more coating layers preferably are selected from the group consisting of an adhesive layer, an alignment layer, a hard coat layer, and a barrier layer.

### BRIEF DESCRIPTION OF THE DRAWINGS

FIGS. 1A and 1B are a side views (not to scale) of heatable optical articles in accordance with some examples of the present disclosure;

FIGS. 2A-2C are side views (not to scale) of electrodes in accordance with some examples of the present disclosure;

FIGS. 3A-3F are side views (not to scale) of heatable optical articles in accordance with some examples of the present disclosure; and

FIG. 4 is a side view (not to scale) of a heatable optical article in accordance with an example of the present disclosure.

### DESCRIPTION OF THE INVENTION

As used herein, the singular form of “a”, “an”, and “the” include plural referents unless the context clearly dictates otherwise.

Spatial or directional terms, such as “left”, “right”, “inner”, “outer”, “above”, “below”, and the like, relate to the invention as shown in the drawing figures and are not to be considered as limiting as the invention can assume various alternative orientations.

Other than in the operating examples, or where otherwise indicated, all numbers expressing quantities of ingredients, reaction conditions, and so forth used in the specification and claims are to be understood as modified in all instances by the term “about”. By “about” is meant plus or minus ten percent of the stated value. However, this should not be considered as limiting to any analysis of the values under the doctrine of equivalents.

Unless otherwise indicated, all ranges or ratios disclosed herein are to be understood to encompass the beginning and ending values and any and all subranges or subratios subsumed therein. For example, a stated range or ratio of “1 to 10” should be considered to include any and all subranges or subratios between (and inclusive of) the minimum value of 1 and the maximum value of 10; that is, all subranges or subratios beginning with a minimum value of 1 or more and ending with a maximum value of 10 or less. The ranges and/or ratios disclosed herein represent the average values over the specified range and/or ratio.

The terms “first”, “second”, and the like are not intended to refer to any particular order or chronology, but refer to different conditions, properties, or elements.

All documents referred to herein are “incorporated by reference” in their entirety.

The term “at least” is synonymous with “greater than or equal to”.

The term “not greater than” is synonymous with “less than or equal to”.

As used herein, “at least one of” is synonymous with “one or more of”. For example, the phrase “at least one of A, B, or C” means any one of A, B, or C, or any combination of any two or more of A, B, or C. For example, “at least one of A, B, or C” includes A alone; or B alone; or C alone; or A and B; or A and C; or B and C; or all of A, B, and C.

As used herein, the term “polymer” means homopolymers (e.g., prepared from a single monomer species), copolymers (e.g., prepared from at least two monomer species), and graft polymers.

As used herein, the term “(meth)acrylate” and similar terms, such as “(meth)acrylic acid ester” means derivatives of acrylic acid and methacrylic acid, inclusive of acrylate esters, methacrylate esters, acrylamides, methacrylamides, acrylic acid and methacrylic acid. As used herein, the term “(meth)acrylic acid” means methacrylic acid and/or acrylic acid.

The term “adjacent” means proximate to and optionally, in direct contact with.

The term “includes” is synonymous with “comprises”.

The term “optical” means pertaining to or associated with light and/or vision. For example, an optical element, article, or device can be chosen from ophthalmic elements, articles, and devices; display elements, articles, and devices; visors; windows; and mirrors.

Non-limiting examples of display devices include augmented reality (AR) and virtual reality (VR) devices.

The term “ophthalmic” means pertaining to or associated with the eye and vision. Non-limiting examples of ophthalmic articles or elements include corrective and non-corrective lenses, including single vision or multi-vision lenses, which may be either segmented or non-segmented multi-vision lenses (such as, but not limited to, bifocal lenses, trifocal lenses, and progressive lenses), as well as other elements used to correct, protect, or enhance (cosmetically or otherwise) vision, including without limitation, contact lenses, intra-ocular lenses, magnifying lenses, and protective lenses or visors.

As used herein, the terms “lens” and “lenses” mean and encompass at least individual lenses, lens pairs, partially formed (or semi-finished) lenses, fully formed (or finished) lenses, and lens blanks.

As used herein, the term “transparent”, such as used in connection with a substrate, film, material, and/or coating, means that the indicated substrate, film, material, and/or coating has the property of transmitting visible light without appreciable scattering so that objects lying beyond are visibly observable.

As used herein, the term “actinic radiation” means electromagnetic radiation that is capable of causing a response in a material, such as, but not limited to, transforming a photochromic material from one form or state to another as will be discussed in further detail herein.

As used herein, the terms “ultraviolet”, “UV”, “ultraviolet light”, or “ultraviolet radiation” mean electromagnetic radiation having a wavelength in the range of 10 nm to 400 nm.

As used herein, the term “coating” means a supported film derived from a flowable coating material, which can optionally have a uniform thickness, and specifically excludes polymeric sheets. The terms “layer” and “film” each encompass both coatings (such as a coating layer or a coating film) and sheets, and a layer can include a combination of separate layers, including sub-layers and/or over-layers. The verb “coating” means, within appropriate context, the process of applying a coating material (or materials) to the substrate to form a coating (or coating layer).

As used herein, the term “dispersion” means a suspension of particles (e.g., conductive nanowires) in water and/or an organic solvent.

As used herein, the terms “sinter” or “sintering” means the application of heat or light to cause a change in a layer or a material. The change may comprise melting of an organic material (e.g., polymers), burning off of an organic material (e.g., polymers), or welding together metallic nanomaterials (e.g., nanowires).

As used herein, the terms “formed over”, “deposited over”, “provided over”, “applied over”, “residing over”, or “positioned over” mean formed, deposited, provided, applied, residing, or positioned on but not necessarily in direct (or abutting) contact with the underlying element, or surface of the underlying element. For example, a layer “positioned over” a substrate does not preclude the presence of one or more other layers, coatings, or films of the same or different composition located between the positioned or formed layer and the substrate.

As used herein, the terms “cure”, “cured”, and related terms, mean that at least a portion of the polymerizable and/or crosslinkable components that form a curable composition are at least partially polymerized and/or crosslinked. In accordance with some examples, the degree of crosslinking can range from 5% to 100% of complete crosslinking. In accordance with some further examples, the degree of crosslinking can range from 30% to 95%, such as 35% to 95%, or 50% to 95%, or 50% to 85% of complete crosslinking. The degree of crosslinking can range between any combination of these recited lower and upper values, inclusive of the recited values.

The discussion of the invention may describe certain features as being “particularly” or “preferably” within certain limitations (e.g., “preferably”, “more preferably”, or “even more preferably”, within certain limitations). It is to be understood that the invention is not limited to these particular or preferred limitations but encompasses the entire scope of the disclosure.

The term “alkyl” as used herein, means linear or branched C₁-C₂₅ alkyl. Linear or branched alkyl can include C₁-C₂₅ alkyl, such as C₁-C₂₀ alkyl, such as C₂-C₁₀ alkyl, such as C₁-C₁₂ alkyl, such as C₁-C₆ alkyl.

The invention comprises, consists of, or consists essentially of the following examples of the invention, in any combination. Various examples of the invention may be discussed separately. However, it is to be understood that this is simply for ease of illustration and discussion. In the practice of the invention, one or more aspects of the invention described in one example can be combined with one or more aspects of the invention described in one or more of the other examples.

The invention is directed to a heatable optical article 10. As used herein “heatable” means capable of being heated upon the addition of electrical energy. The heatable optical article 10 comprises an optical substrate 12 comprising a first surface 14 and a second surface 16 opposite the first surface 14, an electrode 18 located over at least a portion of the first surface 14, a photochromic coating 24 comprising at least one photochromic material, and a power supply 26 electrically connected to the electrode 18. The electrode 18 comprises an electrically conductive three-dimensional network 20.

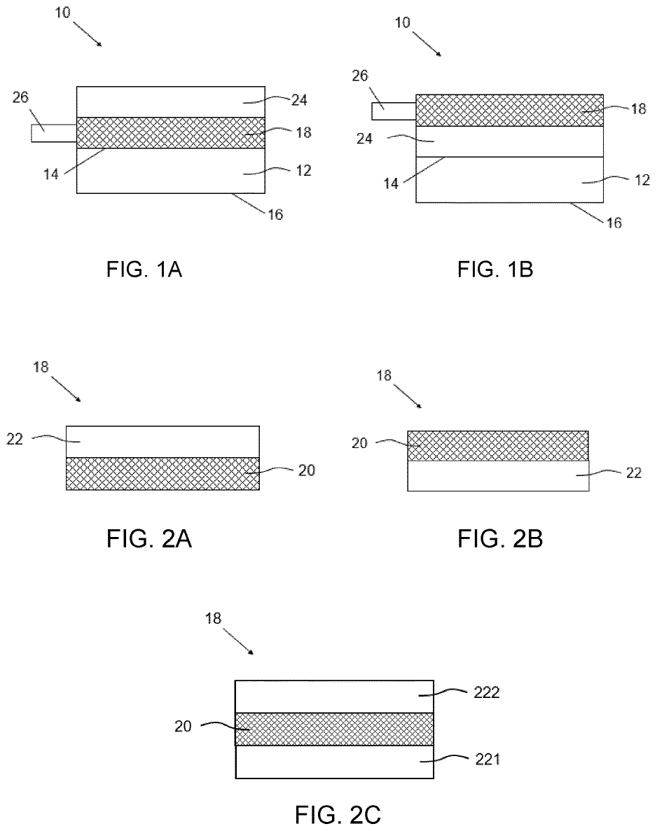

With reference to FIGS. 1A and 1B, the heatable optical article 10 comprises an optical substrate 12. The optical substrate 12 comprises a first surface 14 and a second surface 16 opposite the first surface 14. The optical substrate 12 can be of any desired material having any desired characteristics. In general, the optical substrate 12 can be made of various materials including, but not limited to, organic materials, inorganic materials, or combinations thereof (for example, composite materials).

Specific, non-limiting examples of organic materials that may be used to for the optical substrate 12 disclosed herein include polymeric materials, for example, a polycarbonate, polycyclic alkene, polyurethane, poly(urea)urethane, polythiourethane, polythio(urea)urethane, polyol(allyl carbonate), cellulose acetate, cellulose diacetate, cellulose triacetate, cellulose acetate propionate, cellulose acetate butyrate, poly(vinyl acetate), poly(vinyl alcohol), poly(vinyl chloride), poly(vinylidene chloride), poly(ethylene terephthalate), polyester, polysulfone, polyolefin, polyether, polyamide, polyalkyl (meth)acrylate, polyvinyl butyral, polystyrene, copolymers of two or more thereof, and mixtures of two or more thereof.

Non-limiting examples of inorganic materials suitable for use in forming the optical substrate 12 include glasses, minerals, ceramics, and metals. For example, the optical substrate can comprise glass.

The optical substrates 12 can be untinted, tinted, linearly polarizing, circularly polarizing, elliptically polarizing, photochromic, or tinted-photochromic optical substrates. As used herein, with reference to optical substrates 12, the term “untinted” means optical substrates that are essentially free of coloring agent additions (such as, but not limited to, conventional dyes) and have an absorption spectrum for visible radiation that does not vary significantly in response to actinic radiation. Further, with reference to optical substrates, the term “tinted” means optical substrates that have a coloring agent addition (such as, but not limited to, conventional dyes) and an absorption spectrum for visible radiation that does not vary significantly in response to actinic radiation. As used herein, the term “linearly polarizing” with reference to optical substrates refers to optical substrates that are adapted to linearly polarize radiation (i.e., confine the vibrations of the electric vector of light waves to one direction). As used herein, the term “circularly polarizing” with reference to optical substrates refers to optical substrates that are adapted to circularly polarize radiation. As used herein, the term “elliptically polarizing” with reference to optical substrates refers to optical substrates that are adapted to elliptically polarize radiation. Further, as used herein, with reference to optical substrates, the term “tinted-photochromic” means optical substrates containing a coloring agent addition as well as a photochromic material, and having an absorption spectrum for visible radiation that varies in response to at least actinic radiation. Thus, for example and without limitation, the tinted-photochromic substrate can have a first color characteristic of the coloring agent and a second color characteristic of the combination of the coloring agent the photochromic material when exposed to actinic radiation.

The heatable optical article 10 comprises an electrode 18 located over at least a portion of the first surface 14 of the optical substrate 12. The electrode 18 comprises an electrically conductive three-dimensional network 20. As used herein “an electrically conductive three-dimensional network” means a three-dimensional unstructured array of an electrically conductive material that has a continuous electrical pathway when contacted with electrical energy.

The electrically conductive three-dimensional network 20 comprises an electrically conductive material. Suitable electrically conductive materials for the electrically conductive three-dimensional network can include, but are not limited to conductive nanowires. The conductive nanowires may be selected from the group consisting of silver nanowires, nickel nanowires, copper nanowires, and combinations of two or more thereof. For example, the electrically conductive material of the electrically conductive three-dimensional network 20 may be silver nanowires. The nanowires, e.g., silver nanowires, may optionally be coated with a polymer, such as polyvinylpyrolidone.

For example, the silver nanowires may have a length of from 1 micron (μm) to 100 μm, such as from 5 μm to 60 μm, such as from 10 μm to 30 μm, or such as from 10 μm to 20 μm.

For example, the silver nanowires may have a diameter of from 10 nanometers (nm) to 150 nm, such as from 10 nm to 100 nm, such as from 10 nm to 80 nm, or such as from 10 nm to 60 nm.

The electrode 18 may further comprise an electrically conductive encapsulating layer 22 that is positioned adjacent to and in direct contact with the electrically conductive three-dimensional network 20, as provided in FIGS. 2A and 2B. The electrically conductive encapsulating layer 22 comprises an electrically conductive encapsulating material. Suitable electrically conductive encapsulating materials can include, but are not limited to conductive polymers or doped metal oxides. The electrically conductive encapsulating material of the electrically conductive encapsulating layer 22 may comprise a conductive polymer comprising poly(3,4-ethylenedioxythiophene) polystyrene sulfonate (PEDOT:PSS). The PEDOT:PSS may be optionally doped with dimethyl sulfoxide (DMSO) or methanol. The electrically conductive encapsulating material of the electrically conductive encapsulating layer 22 may comprise a doped metal oxide including, but not limited to aluminum doped zinc oxide or indium doped tin oxide.

The electrically conductive encapsulating layer 22 may be positioned over the electrically conductive three-dimensional network 20 to form the electrode 18, as provided in FIG. 2A. The electrically conductive encapsulating layer 22 may be positioned under the electrically conductive three-dimensional network 20 to form the electrode 18, as provided in FIG. 2B. Alternatively, the electrically conductive three-dimensional network 20 may be positioned between a first electrically conductive encapsulating layer 221 and a second electrically conductive encapsulating layer 222, as provided in FIG. 2C.

The electrode 18 of the heatable optical article 10 comprises a sheet resistance of less than 60 Ohms per square (Ω/□). For example, the sheet resistance of the electrode 18 may be less than 40Ω/□ or less than 30 □/Ω. The sheet resistance may range from 10Ω/□ to 50Ω/□, such as from 15Ω/□ to 40Ω/□, such as from 20Ω/□ to 35Ω/□, such as from 20Ω/□ to 30Ω/□, such as from 10Ω/□ to 20Ω/□. Sheet resistance may be measured by a four-point probe.

With continued reference to FIGS. 1A and 1B, the heatable optical article 10 comprises a photochromic coating 24 comprising at least one photochromic material. As used herein, the term “photochromic material” includes thermally reversible photochromic compounds.

As used herein, to modify the term “state”, the terms “first” and “second” are not intended to refer to any particular order or chronology, but instead refer to two different conditions or properties. For purposes of non-limiting illustration, the first state and the second state of a photochromic material can differ with respect to at least one optical property, such as but not limited to the absorption of visible and/or UV radiation. Thus, the photochromic materials of the present invention can have a different absorption spectrum in each of the first and second state. For example, while not limiting herein, a photochromic material of the present invention can be clear in the first state and colored in the second state. Alternatively, a photochromic material of the present invention can have a first color in the first state and a second color in the second state.

Generally, although not limiting herein, when two or more photochromic materials are used in conjunction with each other, the various materials can be chosen to complement one another to produce a desired color or hue. For example, mixtures of photochromic materials can be used, as disclosed herein, to attain certain activated colors, such as, a near neutral gray or near neutral brown. See, for example, U.S. Pat. No. 5,645,767, column 12, line 66 to column 13, line 19, the disclosure of which is specifically incorporated by reference herein, which describes the parameters that define neutral gray and brown colors.

The photochromic material can comprise any of a variety of organic and inorganic photochromic materials. The photochromic material(s) can include but is not limited to, the following classes of materials: chromenes, e.g., naphthopyrans, benzopyrans, indeno fused naphthopyrans, phenanthropyrans or mixtures thereof; spiropyrans, e.g., spiro(benzindoline) naphthopyrans, spiro(indoline) benzopyrans, spiro(indoline) naphthopyrans, spiro(indoline) quinopyrans and spiro(indoline) pyrans; oxazines, e.g., spiro(indoline) naphthoxazines, spiro(indoline) pyridobenzoxazines, spiro(benzindoline) pyridobenzoxazines, spiro(benzindoline) naphthoxazines and spiro(indoline) benzoxazines; mercury dithizonates, fulgides, fulgimides and mixtures of such photochromic compounds.

The photochromic material of the photochromic coating 24 may be a photochromic-dichroic material. As used herein the term “photochromic-dichroic materials” refers to materials that display photochromic properties and dichroic properties in response to at least actinic radiation. As used herein, the term “dichroic” means capable of absorbing one of two orthogonal plane polarized components of at least transmitted radiation more strongly than the other. For example, a photochromic-dichroic material can be adapted to reversibly transform from a first optically clear (colorless), non-polarizing state in at least the visible spectrum to a second colored, polarizing state in at least the visible spectrum in response to at least actinic radiation. Non-limiting examples of photochromic-dichroic materials include the photochromic-dichroic materials described in U.S. Patent Application Publication No. 2005/0004361, at paragraph 27 to paragraph 158, the disclosure of which is incorporated herein by reference.

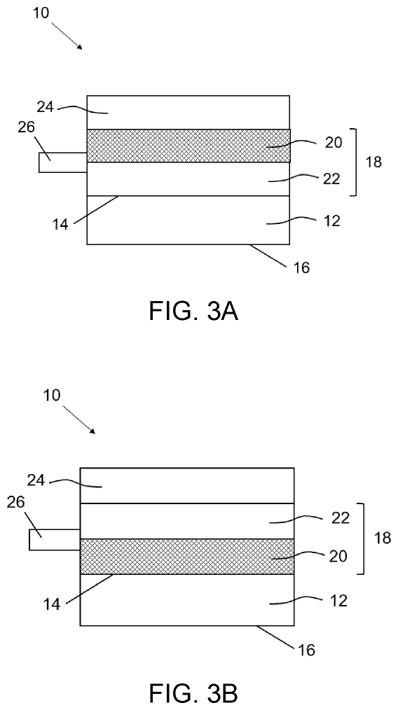

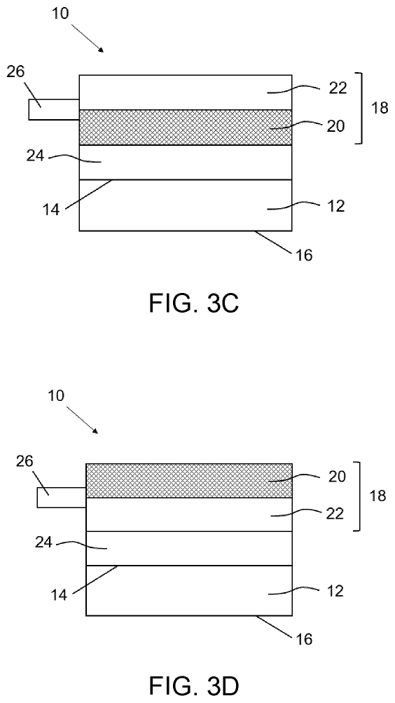

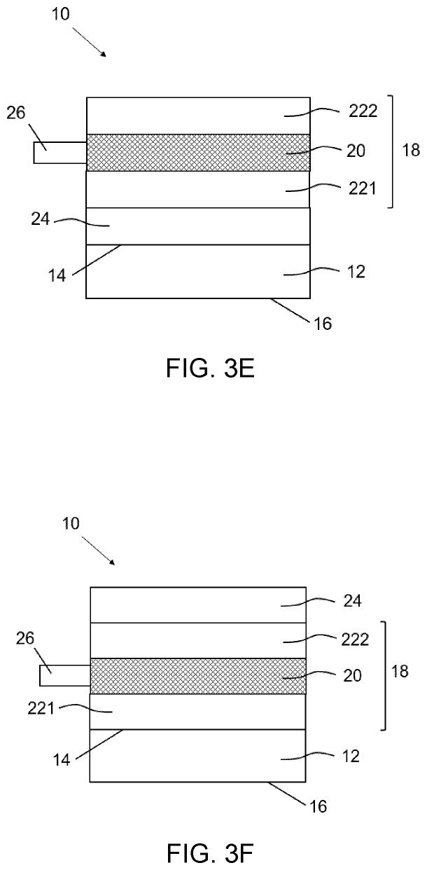

The electrode 18 may be positioned over at least a portion of the first surface 14 of the optical substrate 12 and the photochromic coating 24 may be located over the electrode 18, as provided in FIG. 1A. For example, the photochromic coating 24 may be positioned over the electrically conductive three-dimensional network 20 of the electrode 18, as provided in FIG. 3A.

Alternatively, when the electrode 18 comprises an electrically conductive encapsulating layer 22, the photochromic coating 24 may be positioned over the electrically conductive encapsulating layer 22 of the electrode 18, as provided in FIG. 3B.

Alternatively, the photochromic coating 24 may be positioned over at least a portion of the first surface 14 of the optical substrate 12 and the electrode 18 may be positioned over the photochromic coating 24, as provided in FIG. 1B. For example, while not limiting herein, the photochromic coating 24 may be positioned over at least a portion of the first surface 14 of the optical substrate 12 and the electrically conductive three-dimensional network 20 of the electrode 18 may be positioned over the photochromic coating 24, as provided in FIG. 3C.

Alternatively, when the electrode 18 comprises an electrically conductive encapsulating layer 22, the photochromic coating 24 may be positioned over at least a portion of the first surface 14 of the optical substrate 12 and the electrically conductive encapsulating layer 22 of the electrode may be positioned over the photochromic coating 24, as provided in FIG. 3D.

Alternatively, when the electrode 18 comprises a first electrically conductive encapsulating layer 221 and a second electrically conductive encapsulating layer 222, the photochromic coating 24 may be positioned over at least a portion of the first surface 14 of the optical substrate 12 and the first electrically conductive encapsulating layer 221 of the electrode may be positioned over the photochromic coating 24, as provided in FIG. 3E.

Alternatively, when the electrode 18 comprises a first electrically conductive encapsulating layer 221 and a second electrically conductive encapsulating layer 222, the first electrically conductive encapsulating layer 221 may be positioned over at least a portion of the first surface 14 of the optical substrate 12 and the photochromic coating 24 may be positioned over the second electrically conductive encapsulating layer 222, as provided in FIG. 3F.

The photochromic coating 24 may include a resin. The resin of the photochromic coating can include, but is not limited to: polyurethanes, polyisocyanurates, acrylics, thermoplastic resin compositions, and anisotropic materials. For example, the thermoplastic resin composition may be a thermoplastic polyurethane composition. As used herein, the term “anisotropic” means having at least one property that differs in value when measured in at least one different direction and which are capable of self-assembly. Thus, “anisotropic materials” are materials that have at least one property that differs in value when measured in at least one different direction and which are capable of self-assembly.

The heatable optical article 10 comprises a power supply 26 that is electrically connected to the electrode 18. The power supply 26 may be any suitable power supply, such as a direct current battery, a solar power cell, an alternating current power supply, or combinations thereof. For example, the power supply 26 may be a lithium-ion battery or an alkaline battery. The power supply 26 may be electrically connected to the edge of the electrode 18. For example, the power supply 26 may be electrically connected to the edge of the electrically conductive three-dimensional network 20 and/or the edge of the electrically conductive encapsulating layer 22. Alternatively, the power supply 26 may be electrically connected to one or more bus bars that are in electrical contact with the electrode 18. The power supply 26 applies a voltage to the electrode 18. The power supply 26 may apply from 0.5 Volts (V) to 15 V, such as from 1 V to 10 V, such as from 1 V to 5 V, or such as from 1.5 V to 4 V. Based on the size and the sheet resistance of the electrode 18, a current is generated from the voltage that is applied by the power supply 26 to heat the optical article 10. The current generated depends upon the voltage applied by the power supply 26, the size of the electrode 18, the relative distance between the one or more bus bars (if present), and the sheet resistance of the electrode 18. For example, for an ophthalmic lens-sized heatable optical article 10, the power supply 26 would be selected within the described voltage ranges to deliver a current of from 0.2 ampere (amp) to 0.8 amp. One having ordinary skill in the art would recognize that the dimensions of the heatable optical article 10 will determine the total resistance and current, as well as the number of bus bars needed (if using), required to heat the optical article 10.

The voltage of the power supply 26 may be selected in order to raise the temperature of the heatable optical article 10 by at least 2° C., such as by at least 5° C. or such by at least 10° C. The voltage of the power supply 26 may be selected in order to heat the heatable optical article 10 to a temperature of at least 20° C., at least 25° C., at least 27° C., at least 30° C., at least 35° C., or at least 37° C. The voltage of the power supply 26 may be selected in order to heat the heatable optical article 10 to a temperature in the range of from at least 20° C. to at least 37° C., such as from at least 20° C. to at least 35° C., such as from at least 20° C. to at least 25° C., such as from at least 25° C. to at least 30° C., such as at least 20° C. to at least 30° C., or such as from at least 25° C. to at least 37° C. The voltage may be applied from the power supply 26 continuously or pulsed for specified time, such as for at least 20 seconds, at least 30 seconds, at least 40 seconds, at least 50 seconds, at least 60 seconds, or greater than 60 seconds to achieve the desired fade rate.

The heatable optical article 10 may comprise one or more bus bars and/or electrical leads that are in electrical contact with the electrode 18 and the one or more bus bars and/or electrical leads are electrically connected to the power supply 26. The bus bars have a lower resistivity compared to the electrode 18 and are intended to distribute the electrical current from the power supply 26 evenly over the electrode 18 to heat the optical article 10. For example, the heatable optical article 10 may include two or more bus bars positioned on at least one surface of the electrode 18 along opposite sides, and the power supply 26 is connected to the two or more bus bars. The bus bars may be made of any suitable material, such as a metallic foil strip, deposited metallic layers, or combinations thereof. Alternatively, the bus bars may be printed onto the electrode 18 with a conductive ink, such as a colloidal silver epoxy ink. The bus bars may be configured as parallel strips on opposite sides of the electrode 18 and connected to the power supply 26. Alternatively, electrical leads may be attached to each bus bar and extend away from the opposite edges of the optical substrate 12 and be connected to the power supply 26.

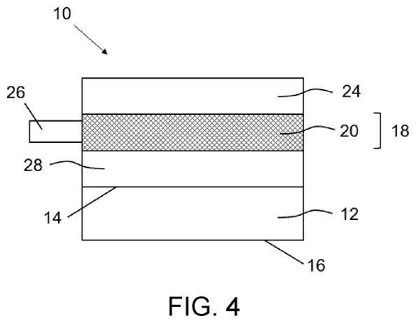

The heatable optical article 10 may further comprise an adhesive layer 28. The adhesive layer 28 may be included to increase the adhesion of the electrode 18 to the optical substrate 12 or underlying layers. The adhesive layer 28 may be located over at least a portion of the first surface 14 of the optical substrate 12 and the electrode 18 may be located over the adhesive layer 28, as shown in FIG. 4. For example, the adhesive layer 28 may be located over at least a portion of the first surface 14 of the optical substrate 12 and the electrically conductive three-dimensional network 20 of the electrode 18 may be positioned over the adhesive layer 28. The adhesive layer 28 comprises an adhesive that includes but is not limited to, polyvinyl butyral, poly(meth)acrylates, hydroxyl-functional poly(meth)acrylates, poly(2-hydroxyethyl methacrylate), combinations thereof, and mixtures thereof. For example, the hydroxyl-functional poly(meth)acrylate may be poly(2-hydroxyethyl methacrylate).

The heatable optical article 10 may optionally comprise one or more additional coating layers. The additional coating layers may include, but are not limited to: alignment layers, primer layers, hard coat layers, barrier layers, topcoat layers, antireflective layers, and combinations thereof.

The heatable optical article 10 may optionally comprise an alignment layer that is positioned adjacent to the photochromic coating 24. As used herein the term “alignment layer” means a layer that can facilitate the positioning of one or more other structures that are exposed, directly and/or indirectly, to at least a portion thereof. For example, when the electrode 18 is located over the photochromic coating 24, the alignment layer may be positioned over at least a portion of the first surface 14 of the optical substrate 12 and the photochromic coating 24 may be positioned over the alignment layer. When the photochromic coating 24 is located over the electrode 18, the alignment layer may be positioned over at least a portion of the electrode 18 and the photochromic coating 24 may be positioned over the alignment layer. Thus, the alignment layer may be positioned over the electrically conductive three-dimensional network 20 of the electrode 18 or the electrically conductive encapsulating layer 22 of the electrode 18, if present.

As used herein the term “order” means bring into a suitable arrangement or position, such as, aligning with another structure or material, or by some other force or effect. Thus, as used herein the term “order” encompasses both contact methods of ordering a material, such as, by aligning with another structure or material, and non-contact methods of ordering a material, such as, by exposure to an external force or effect. The term order also encompasses combinations of contact and non-contact methods.

The alignment layer may be used to at least partially align the polymerizable anisotropic materials of the photochromic coating 24, if present, and/or the photochromic-dichroic material of the photochromic coating 24, if present. For example, when the photochromic material of the photochromic coating 24 comprises a photochromic-dichroic material, the photochromic-dichroic material that is at least partially aligned by interaction with the optional alignment layer can be at least partially aligned such that the long-axis of the photochromic-dichroic material in the activated state is essentially parallel to at least the first general direction of the alignment layer. The photochromic-dichroic material that is at least partially aligned by interaction with the alignment layer may be bound to or reacted with the alignment layer. As used herein with reference to order or alignment of a material or structure, the term “general direction” refers to the predominant arrangement or orientation of the material, compound, or structure. Further, it will be appreciated by those skilled in the art that a material, compound or structure can have a general direction even though there is some variation within the arrangement of the material, compound, or structure, provided that the material, compound, or structure has at least one predominate arrangement.

The alignment layer can have at least a first general direction. For example, the alignment layer can include a first ordered region having a first general direction and at least one second ordered region adjacent the first ordered region having a second general direction that is different from the first general direction. Further, the alignment layer can have a plurality of regions, each of which has a general direction that is the same or different from the remaining regions so as to form a desired pattern or design. The alignment layer can include, for example, a coating including an at least partially ordered alignment medium, an at least partially ordered polymer sheet, an at least partially treated surface, Langmuir-Blodgett films, and combinations thereof. Examples of suitable alignment layers are disclosed in WO 2022/100816 at paragraphs [00112] to [00123], the pertinent portions of which are incorporated herein by reference.

The heatable optical articles 10 of the present invention can include a primer layer. The primer layer may be positioned between the first surface 14 of the optical substrate 12 and the photochromic coating 24. Examples of a suitable primer layer includes, but is not limited to a thermoset polyurethane layer. The primer layer can include a single layer or multiple layers each optionally including fixed-tint dyes, photochromic dyes, or combinations thereof.

As used herein, the term “fixed-tint dye” means dyes which do not physically or chemically respond to electromagnetic radiation with regard to the visually observed color thereof. The term “fixed-tint dye” and related terms as used herein does not include and is distinguishable from a photochromic compound.

The heatable optical article 10 may optionally comprise a barrier layer. The barrier layer may be positioned between the electrode 18 and the photochromic coating 24. Examples of suitable barrier layers include, but are not limited to, polyvinyl alcohol and sol-gel coatings.

The heatable optical article 10 may optionally comprise a topcoat layer. The topcoat layer may be positioned over the photochromic coating 24 when the photochromic coating 24 is located over the electrode 18. The topcoat layer typically includes an organic matrix, such as a thermoplastic organic matrix and/or a crosslinked organic matrix. Additionally or alternatively to an organic matrix, the topcoat layer can include an inorganic matrix, including, for example, silane linkages, siloxane linkages and/or titanate linkages. The organic matrix can include, for example: acrylate residues (or monomer units) and/or methacrylate residues; vinyl residues; ether linkages; sulfide linkages, including monosulfide linkages and/or polysulfide linkages; carboxylic ester linkages; carbonate linkages, urethane linkages; and/or thiourethane linkages. The topcoat layer can include a single layer or multiple layers each optionally including tint dyes, photochromic dyes, or combinations thereof, that can be the same or different.

Compositions from which the topcoat layer is formed can include one or more additives, including, but not limited to, adhesion promoters, coupling agents, ultraviolet light absorbers, thermal stabilizers, catalysts, free radical scavengers, plasticizers, flow additives, and/or static tints or static dyes (i.e., tints or dyes that are not photochromic).

The heatable optical article 10 may optionally include a hard coat layer. Examples of a suitable hard coat layer include, but are not limited to, those described in U.S. Pat. No. 8,545,015 B2 at column 55 line 49 to column 56 line 31, the disclosure of which is incorporated herein by reference. The hard coat layer can include a single layer or multiple layers. When the photochromic coating 24 is located over at least a portion of the first surface 14 of the optical substrate 12 and the electrode 18 is located over the photochromic coating 24, the hard coat layer may be positioned over the electrode 18. When the electrode 18 is located over at least a portion of the first surface 14 of the optical substrate 12 and the photochromic coating 24 is located over the electrode 18, the hard coat layer may be located over the photochromic coating 24. The hard coat layer may extend over the edges of the heatable optical article 10 to encapsulate the heatable optical article 10.

The heatable optical articles 10 of the present invention may optionally include an antireflective coating. For example, an antireflective coating can be applied over the hard coat layer. Examples of antireflective coatings are described in U.S. Pat. No. 6,175,450 and International Patent Application Publication No. WO 00/33111, the disclosures of which are incorporated herein by reference.

The heatable optical articles 10 of the present invention may have a visible light transmittance of at least 75%, at least 80%, or at least 85% when the photochromic material of the photochromic coating 24 is in the unactivated or colorless state. The heatable optical articles 10 of the present invention may have a haze value of less than 6%, such as less than 4%, or such as less than 2.5%, when measured using a haze-gard plus (BYK-Gardner) according to ASTM D1003 (method B) or a UltraScan Pro spectrophotometer.

The present invention is also directed to a method of making a heatable optical article 10. The method comprises applying an electrode 18 over at least a portion of a first surface 14 of an optical substrate 12. The optical substrate 12 may be any optical substrate 12 described herein. Applying the electrode 18 comprises applying a dispersion comprising an electrically conductive material and sintering the electrically conductive material to form an electrically conductive three-dimensional network 20. The electrode 18, the electrically conductive material, and the electrically conductive three-dimensional network 20 may be any electrode 18, electrically conductive material, or electrically conductive three-dimensional network 20 described herein. The method further comprises applying a photochromic coating 24 comprising at least one photochromic material and connecting a power supply 26 to the electrode 18. The photochromic coating 24 and power supply 26 may be any of the photochromic coatings 24 and power supplies 26 described herein.

The photochromic coating 24 may be applied over at least a portion of the first surface 14 of the optical substrate 12 and the electrode 18 may be applied over the photochromic coating 24. Alternatively, the electrode 18 may be applied over at least a portion of the first surface 14 of the optical substrate 12 and the photochromic coating 24 may be applied over the electrode 18.

The electrically conductive three-dimensional network 20 of the electrode 18 may be formed by applying a dispersion comprising the electrically conductive material and sintering the electrically conductive material to form the electrically conductive three-dimensional network 20. The dispersion comprising the electrically conductive material may be a dispersion having an electrically conductive material and a dispersion medium. The dispersion medium can include, but is not limited to, water, anisole, methanol, isopropyl alcohol, ethanol, or combinations thereof. For example, the dispersion comprising the electrically conductive material may comprise water, anisole, and isopropyl alcohol. The electrically conductive material may be present in the dispersion in an amount from 0.05 to 5 percent by weight. The dispersion comprising the electrically conductive material may be applied in accordance with art-recognized methods including, but not limited to: spray application methods, curtain coating application methods, draw-down blade (or bar) application methods, dip-coating application methods, spin-coating application methods, jet printing methods (such as inkjet printing methods, where the “ink” is replaced with the dispersion comprising the electrically conductive material according to the present invention), and combinations thereof.

The electrically conductive three-dimensional network 20 may be achieved by applying multiple layers of the electrically conductive material. For example, applying from 2 layers to 9 layers, such as from 2 layers to 7 layers, such as from 2 layers to 4 layers, such as 2 layers, such as 3 layers, or such as 4 layers, of the dispersion comprising the electrically conductive material may be applied.

Each layer of electrically conductive material may be dried prior to the application of the sequential layer of electrically conductive material. For example, each layer of electrically conductive material may be dried at temperatures ranging from ambient temperatures (e.g. about 20° C. to about 25° C.) to about 150° C. for 10 seconds to 10 minutes to remove the one or more dispersion mediums.

Each electrically conductive layer may be sintered individually to form the electrically conductive three-dimensional network 20. Alternatively, from 2 to 9 layers of electrically conductive material may be sintered simultaneously to form the electrically conductive three-dimensional network 20. The electrically conductive layers may be sintered using electromagnetic radiation, such as UV radiation having a wavelength of from 300 nanometers (nm) to 450 nm, to form the electrically conductive three-dimensional network 20. For example, the source of the electromagnetic radiation may be a solar lamp, a mercury lamp, a mercury lamp doped with FeI₃ or GaI₃, a light emitting diode, a germicidal lamp, a xenon lamp, a tungsten lamp, a metal halide lamp, or a combination of such lamps. The exposure time of the electrically conductive material to the electromagnetic radiation source will vary depending upon the wavelength and intensity of the electromagnetic radiation source. The electrically conductive material may be exposed to the electromagnetic radiation source for a sufficient time to cause local heating of the electrically conductive material (e.g., conductive nanowires) to increase the conductivity (e.g., decrease the resistance) within the three-dimensional network 20. For example, when the electromagnetic source is a source that emits only UV radiation, the electrically conductive material may be exposed to the electromagnetic radiation source for 10 seconds to 3 minutes. When the source is a solar lamp, the electrically conductive material may be exposed for 30 seconds to 1 hour.

Forming the electrode 18 may further comprise applying an electrically conductive encapsulating material adjacent to the electrically conductive three-dimensional network 20 to form an electrically conductive encapsulating layer 22.

When the electrically conductive encapsulating material comprises a conductive polymer as described herein, the electrically conductive encapsulating layer 22 may be formed by applying an electrically conductive encapsulating material solution, wherein the electrically conductive encapsulating material solution comprises the conductive polymer and one or more solvents. The solvents may include, but are not limited to, water, anisole, methanol, isopropyl alcohol, ethanol, dimethyl sulfoxide (DMSO), and combinations thereof. For example, the electrically conductive encapsulating material solution may comprise water and the conductive polymer in an amount ranging from at least 0.25 weight % to 5 weight %, or such as from at least 0.5 weight % to 3 weight %, based on the total weight of the electrically conductive encapsulating material solution. The electrically conductive encapsulating material solution comprising the conductive polymer may be applied in accordance with art-recognized methods including, but not limited to: spray application methods, curtain coating application methods, draw-down blade (or bar) application methods, dip-coating application methods, spin-coating application methods, jet printing methods (such as inkjet printing methods, where the “ink” is replaced with the electrically conductive encapsulating material solution according to the present invention), and combinations thereof.

When the electrically conductive encapsulating material comprises a doped metal oxide as described herein, the electrically conductive encapsulating material may be applied by any suitable method, including but not limited to, those methods listed above, chemical vapor deposition (CVD), magnetron sputtering vapor deposition (MSVD), plasma vapor deposition, spray pyrolysis, and combinations thereof.

The photochromic coating 24 may be applied from a photochromic coating composition as described herein above. The photochromic coating composition may be applied in accordance with art-recognized methods including, but not limited to: spray application methods, curtain coating application methods, draw-down blade (or bar) application methods, dip-coating application methods, spin-coating application methods, jet printing methods (such as inkjet printing methods, where the “ink” is replaced with the photochromic coating composition according to the present invention), and combinations thereof.

When the photochromic coating composition used to form the photochromic coating 24 comprises polymerizable anisotropic materials as described herein above, the photochromic coating 24 may be at least partially cured or at least partially polymerized by any method known in the art, such as, those disclosed in U.S. Pat. No. 7,910,019 at column 38, lines 24 through 38, the disclosure of which is incorporated herein by reference. Non-limiting examples of suitable curing methods include exposing the photochromic coating composition to UV radiation, visible radiation, gamma radiation, microwave radiation, electron radiation, thermal energy, or combinations of any of these curing methods.

In the present invention, at least one of the electrically conductive material of the electrically conductive three-dimensional network 20, the electrically conductive encapsulating material of the electrically conductive encapsulating layer 22, or the photochromic coating 24 is applied by spin coating. For example, the electrically conductive three-dimensional network 20, the electrically conductive encapsulating layer 22, and the photochromic coating 24 may be applied by spin coating.

The method of the present invention may further comprise applying one or more additional coating layers, including but not limited to: alignment layers, primer layers, hard coat layers, barrier layers, topcoat layers, antireflective layers, and combinations thereof. The additional coating layers may be applied in accordance with art-recognized methods including, but not limited to: spray application methods, curtain coating application methods, draw-down blade (or bar) application methods, dip-coating application methods, spin-coating application methods, jet printing methods (such as inkjet printing methods, where the “ink” is replaced with the coating layer material according to the present invention), and combinations thereof.

The heatable optical article 10 described herein can be used as optical elements selected from the group consisting of ophthalmic articles, display articles, windows, and mirrors. The heatable optical articles 10 are especially useful for ophthalmic articles selected from the group consisting of corrective lenses, non-corrective lenses, contact lenses, and protective lenses. Preparation of visors, face-shields, intraocular lenses, and magnifying lenses also is contemplated.

The present invention is described in the following illustrative, non-limiting examples. Numerous possible modifications and variations will be apparent to those skilled in the art.

### EXAMPLES

### Part A. Preparation of Compositions

Conductive Coating 1 (CC-1): A 5 milligram per milliliter (mg/mL) dispersion of silver nanowires (diameter 20 nm×L 12 μm) in water purchased from Sigma-Aldrich.
Conductive Coating 2 (CC-2): A 5 mg/mL dispersion of silver nanowires (diameter 20 nm×L 12 μm) in 2-propanol purchased from Sigma-Aldrich.
Conductive Coating 3 (CC-3): The materials in Table 1 were combined in a vial, then mixed for 15 minutes on a BT Lab Systems Roller Mixer at a speed of 24 revolutions per minute (RPM).

TABLE 1
⅓ dilution of nanowire coating

| Conductive Coating 3: | Parts by weight |
|---|---|
| CC-1 | 10.0 |
| 2-propanol | 18.0 |
| Anisole | 2.0 |

Encapsulating Coating 4 (EC-4): The materials in Table 2 were combined in a vial, then mixed for 15 minutes on a BT Lab Systems Roller Mixer at a speed of 24 RPM.

TABLE 2
Aluminum doped zinc oxide encapsulating coating

| Encapsulating Coating 4 | Parts by weight |
|---|---|
| Aluminum doped Zinc oxide ink⁽¹⁾ | 10.0 |
| 2-propanol | 10.0 |

⁽¹⁾A 2.5 wt. % suspension (viscosity 2.2 centipoise (cP), work function −3.9 electronvolt (eV)) available from Sigma-Aldrich

Encapsulating Coating 5 (EC-5) was formed according to Table 3 by first adding dimethylsulfoxide (DMSO) to the PEDOT:PSS, mixing using a Fisherbrand™ Analog Vortex Mixer on setting 5 for 30 seconds and filtering through a 5-micron cellulose acetate filter. Then, deionized (DI) water was added to the vial and this set on a BT Lab Systems Roller Mixer at a speed of 25 RPM for 15 minutes.

TABLE 3
PEDOT:PSS encapsulating coating

| Encapsulating Coating 5 | Parts by weight |
|---|---|
| CLEVIOS ™ PH1000⁽²⁾ | 23.75 |
| DMSO | 1.25 |
| DI water | 25.0 |

⁽²⁾A (Poly(3,4-ethylenedioxythiophene)-poly(styrenesulfonate)) [PEDOT:PSS] dispersion in water available from Heraeus

### Part B. Application of Electrode Layer(s)

For each example, hard-coated polycarbonate lenses (0 base, 76 mm diameter and 1.5 mm thickness) were cleaned with a paper cloth dampened with isopropanol. The cleaned test substrates were corona-treated with a Power Generator HV 2000 (serial no. 020270) from Tantec EST Inc. set at 70 kiloVolts (kV) and 1000 Watts (W) with a belt speed of 3 feet per minute (ft/min) prior to applying coating compositions.

The lens was spin-coated with the conductive coating formula indicated in Table 4 using a spin processor from Laurell Technologies Corp. (WS-650-MZ-23NPPB) at 1,000 rpm for four seconds, followed by 1,700 rpm for eight seconds and allowed to air dry for 3 minutes. For samples with multiple applications, the applied layer was air dried for 3 minutes before applying subsequent layers. Once all applications of conductive coating formula were completed and air dried for 3 minutes, the samples were sintered under UV light; the energy density that each coating was exposed to was measured using a UV Power Puck™ II high energy radiometer (S/N: 27840) from Uvitron International, Inc. as follows: UV-V of 0.458 Joules per square centimeter (J/cm²), UV-A of 0.536 J/cm², UV-B of 0.026 J/cm², and UV-C of 0.031 J/cm². Next, each sample was plasma-treated with a Plasma-finish V 55 GKM (serial no. 32-97) supplied with a PE-1000 AC Plasma Power Supply. The plasma treater was configured to run with a base pressure of 20 Pascals (Pa), gas stabilization time of 30 seconds, gas flow rate of 50 milliliters per minute (mL/min), microwave power of 120 W and a treatment time of 60 seconds.

For Examples 6, 7, 9 and 10, an encapsulating layer was applied after the final plasma treatment described above. Approximately 1 milliliter (mL) of the specified encapsulating coating formula was applied to a portion of the lens surface. The lens was spun using a spin processor at 500 rpm for 5.5 seconds, 2000 rpm for 15 seconds, followed by 4000 rpm for 5 seconds. Next, the lens was placed in a forced air convection oven set at 80° C. for five minutes. A second plasma-treatment step was then performed at the surface of Conductive Coating 4, using the same conditions as previously described.

Comparative Examples 11 and 12 were prepared by spin coating the respective encapsulating coating directly to the prepared substrate. The coated substrates were placed in a forced air convection oven set at 80° C. for five minutes. A plasma-treatment step was then performed at the surface of the encapsulating coating. Comparative example 13 is a control of the prepared, uncoated, substrate.

Each lens in examples 1 through 13 was subsequently coated with bus bars, a photochromic layer, a protective layer, and a hardcoat layer as described in the following. A CircuitWorks® Silver Conductive Pen Micro Tip (model CW2200MTP available from Chemtronics®) was used to apply two bus bars to the electrode surface of each Example. The bus bars were 5 millimeter (mm) by 40 mm, and placed parallel at a distance of 30 mm apart. Next, each coated lens was placed in a forced air convection oven set at 125° C. for five minutes. A piece of TapeCase BA series Polyimide Tape with Acrylic Adhesive (Model Number: TCB031-12-55-PARENT) was then applied over the busbars. Then each lens was plasma-treated with a Plasma-finish V 55 GKM (serial no. 32-97) supplied with a PE-1000 AC Plasma Power Supply.

After plasma treatment a curable polyurethane photochromic layer was applied to each lens via a spin coating process. Each lens after being spin coated was placed in a forced air convection oven set at 40° C. to hold until all lenses were coated, then all lenses were placed in a forced air convection oven set at 125° C. for one hour. After curing and cooling, each lens was plasma treated with a Plasma-finish V 55 GKM supplied with a PE-1000 AC Plasma Power Supply. Next, an acrylic protective coating was applied to each lens via spin coating process. Next, using a conveyor system (6 ft/min), each lens was passed through a nitrogen purged chamber fitted with a series of D Type bulbs positioned above glass windows on the top of the chamber. The energy density that each coating was exposed to was measured using a UV Power Puck™ II high energy radiometer from Uvitron International, Inc. as follows: UV-V of 4.776 J/cm², UV-A of 4.753 J/cm², UV-B of 0.100 J/cm², and UV-C of 0.699 J/cm². Each example was plasma treated as described above.

Finally, a HI-GARD® 1080S (available from PPG Industries) hard coat was applied to each sample using a spin coating process. The coated samples were placed in a forced air convection oven set to 105° C. for three hours.

### Part C. Sheet Resistance of Substrate/Electrode; % Haze and % Transmittance of Fully Coated Samples

In the examples below, sheet resistances before sintering of the conductive layer, after sintering of the conductive layer and after plasma-treatment of the encapsulating layer were measured using a R CHEK™ 4 Point Meter. Haze and percent transmittance were measured for each fully-coated sample (up to hardcoat) using a UltraScan PRO Spectrophotometer from HunterLab (USP2253). The software used to process the transmittance and haze values was EasyMatch QC ver 4.96.

TABLE 4
Sheet resistance of substrate with coated electrode layer(s), and haze
and percent transmittance of the fully-coated samples up to hardcoat

| | Conductive Layer | | | Sheet resistance (Ω/□) | | | | |
|---|---|---|---|---|---|---|---|---|
| | | # of | Encapsulating | Before | After | After | % | % |
| Example | Type | layers | layer | sintering⁽³⁾ | sintering⁽⁴⁾ | plasma⁽⁵⁾ | Haze⁽⁷⁾ | Transmittance⁽⁷⁾ |
| 1 | CC-1 | 1 | None | 210 | 55 | 48 | 0.95 | 84 |
| CE-2 | CC-2 | 1 | None | 12 | 6 | 13 | 8.16 | 59 |
| CE-3 | CC-3 | 1 | None | 1350 | 138 | 112 | 0.59 | 86 |
| 4 | CC-3 | 2 | None | 183 | 53 | 45 | 0.78 | 85 |
| 5⁽⁶⁾ | CC-3 | 2 | None | 203 | 56 | 51 | 0.79 | 84 |
| 6 | CC-3 | 2 | EC-4 | 89 | 39 | 34 | 0.88 | 82 |
| 7 | CC-3 | 2 | EC-5 | 120 | 42 | 35 | 0.85 | 83 |
| 8 | CC-3 | 3 | None | 60 | 28 | 29 | 0.93 | 83 |
| 9 | CC-3 | 3 | EC-4 | 47 | 24 | 24 | 1.01 | 81 |
| 10 | CC-3 | 3 | EC-5 | 48 | 25 | 22 | 1.09 | 80 |

| CE-11 | None | 0 | EC-4 | Not conductive | | 0.61 | 86 |
|---|---|---|---|---|---|---|---|
| CE-12 | None | 0 | EC-5 | 1000 | Not conductive | 0.39 | 88 |

| | | | | | | |
|---|---|---|---|---|---|---|
| CE-13 | None | 0 | None | Not conductive | 0.46 | 87 |

⁽³⁾The sheet resistance was measured using a R CHEK ™ 4 Point Meter from EDTM (Model# RC2175) after all silver nanowire (CC) coatings were applied, prior to sintering.
⁽⁴⁾The sheet resistance was measured after sintering the silver nanowire layer. In examples with a conductive encapsulating layer, the sheet resistance reported is prior to the application of the encapsulating layer.
⁽⁵⁾The sheet resistance was measured after plasma treatment of the last layer applied to the sample.
⁽⁶⁾Prior to applying the conductive coating CC-3, an adhesive layer formed from a solution of 2.0 parts poly methyl methacrylate (Molecular weight 15,000) in 100 parts butylacetate was applied by spin coating, then placed in a forced air convection oven set at 70° C. for five minutes. After cooling to room temperature the example was corona-treated as described above, followed by application of the conductive coating layers.
⁽⁷⁾The % haze and % transmittance measurements were performed on the fully-coated samples, up to the cured hardcoat layer.

As shown in Table 4, a single coating layer of conductive nanowires can yield unpredictable results, such as variable sheet resistance, haze and/or percent transmittance. The application of multiple layers of reduced concentrations can produce electrodes with high transmittance, low haze and improved sheet resistance. The sintering of the nanowire layer improves sheet resistance further, as well as the addition of an encapsulating layer.

### Part D. Photochromic Articles

A subset of the examples above, indicated in Table 5, were subsequently evaluated for photochromic performance, both with and without current applied through the bus bars. Lens samples were measured using a proprietary software controlled optical bench utilizing; a temperature regulated sample chamber, a solar simulated activation UV light source, a white light reference/measurement source, collection optics, and spectrophotometer. Transmittance was collected via a ZEISS® Model MCS 601 spectrophotometer. Response measurements, in terms of a change in optical density (ΔOD) from the unactivated or bleached state to the activated or colored state were determined by establishing the initial unactivated transmittance, % Tb. Change in optical density was determined according to the formula: ΔOD=log(10)(% Tb/% Ta), where % Tb is the percent transmittance in the bleached (unactivated) state, % Ta is the percent transmittance in the activated state. Delta Optical density measurements were based on photopic optical density. The ΔOD at saturation was recorded after 15 minutes of activation at 23° C. The Fade Half-life (“T_{1/2}”) value is the time interval in seconds for the ΔOD of the activated form of the photochromic material in the coating to reach one half the ΔOD recorded after 15 minutes of activation at 23° C. described above, after removal of the activating light source.

Once the examples had been evaluated for photochromic response in the absence of applied voltage, the samples were conditioned for a second measurement; first exposing the samples to UV radiation to establish a full activated state, then placing in an oven for 30 minutes at 50° C., followed by complete darkness for 60 minutes. Following the conditioning steps, an external 3.7 V DC power supply was attached to the bus bars via wire leads. The samples were placed in the optical bench and subjected to the same activation conditions as previously described. At the moment the activating light source was removed, the power supply was turned on to supply 3.7 V volts across the bus bars for a duration of 60 seconds and the fade speed (T_{1/2}) was determined simultaneously. The corresponding increase of lens surface temperature (ΔTemp) in the center of the lens between the bus bars was recorded using a FLIR ETS320 infrared camera (available from Teledyne FLIR LLC).

TABLE 5
Performance with and without applied voltage

| | ΔOD at | T_{1/2} (sec) | | ΔTemp⁽⁸⁾ |
|---|---|---|---|---|
| Example | saturation | no voltage | 3.7 V applied | (° C.) |
| 4 | 0.92 | 64 | 51 | 2 |
| 6 | 0.90 | 64 | 45 | 4 |
| 7 | 0.87 | 67 | 36 | 6 |
| 9 | 0.89 | 65 | 37 | 8 |
| 10 | 0.85 | 72 | 35 | 9 |
| CE-11 | 0.90 | 66 | 66 | 0 |
| CE-12 | 0.89 | 69 | 69 | 0 |
| CE-13 | 0.83 | 68 | 69 | 0 |

⁽⁸⁾Increase in lens surface temperature from initial lens temperature (23° C.) after 60 sec pulse at 3.7 V across the bus bars, recorded in the center of the lens

3.7 V across the bus bars, recorded in the center of the lens

The results in Table 5 demonstrate that even small temperature rise can improve fade speeds by a significant amount. With a constant applied voltage, lower sheet resistance results in higher temperature increases and faster fade speeds. The comparative examples, using only the encapsulating compositions or no electrode at all exhibit neither a temperature increase nor a change in fade speed upon application of voltage.

The present invention has been described with reference to specific details of particular embodiments thereof. It is not intended that such details be regarded as limitations upon the scope of the invention except insofar as and to the extent that they are included in the accompanying claims.

1. A heatable optical article, comprising:
an optical substrate comprising a first surface and a second surface opposite the first surface;
an electrode located over at least a portion of the first surface, wherein the electrode comprises an electrically conductive three-dimensional network;
a photochromic coating comprising at least one photochromic material; and
a power supply electrically connected to the electrode.

2. The optical article of claim 1, wherein:
the photochromic coating is located over at least a portion of the first surface and the electrode is located over the photochromic coating; or
the electrode is located over at least a portion of the first surface and the photochromic coating is located over the electrode.

3. The optical article of claim 1, further comprising one or more bus bars or electrical leads in electrical contact with the electrode, wherein the one or more bus bars or electrical leads are electrically connected to the power supply.

4. The optical article of claim 1, wherein the electrically conductive three-dimensional network comprises an electrically conductive material comprising conductive nanowires.

5. The optical article of claim 4, wherein the conductive nanowires are selected from the group consisting of silver nanowires, nickel nanowires, copper nanowires, and combinations of two or more thereof.

6. The optical article claim 1, wherein the electrode further comprises an electrically conductive encapsulating layer adjacent to the electrically conductive three-dimensional network.

7. The optical article of claim 6, wherein the electrically conductive encapsulating layer comprises an electrically conductive encapsulating material selected from the group consisting of a conductive polymer and a doped metal oxide.

8. The optical article of claim 7, wherein the conductive polymer comprises poly(3,4-ethylenedioxythiophene) polystyrene sulfonate (PEDOT:PSS).

9. The optical article of claim 7, wherein the electrically conductive encapsulating material comprises a doped metal oxide selected from aluminum doped zinc oxide or indium doped tin oxide.

10. The optical article of claim 1, further comprising an adhesive layer located over at least a portion of the first surface,
wherein the electrode is located over the adhesive layer, and
wherein the adhesive layer comprises an adhesive selected from the group consisting of polyvinyl butyral, poly(meth)acrylates, hydroxyl-functional poly(meth)acrylates, and combinations thereof.

11. The optical article of claim 1, further comprising one or more coating layers, wherein the one or more coating layers preferably are selected from the group consisting of an alignment layer, a primer layer, a hard coat layer, and a barrier layer.

12. The optical article of claim 1, wherein the electrode has a sheet resistance of less than 60 Ohms per square (Ω/□).

13. The optical article of claim 1, wherein the optical article has a visible light transmittance of at least 75%.

14. The optical article of claim 1, wherein the substrate comprises a polymeric material selected from the group consisting of polycarbonate, polycyclic alkene, polyurethane, poly(urea)urethane, polythiourethane, polythio(urea)urethane, polyol(allyl carbonate), cellulose acetate, cellulose diacetate, cellulose triacetate, cellulose acetate propionate, cellulose acetate butyrate, poly(vinyl acetate), poly(vinyl alcohol), poly(vinyl chloride), poly(vinylidene chloride), poly(ethylene terephthalate), polyester, polysulfone, polyolefin, polyether, polyamide, polyalkyl(meth)acrylate, polyvinyl butyral, polystyrene, copolymers of two or more thereof, and mixtures of two or more thereof.

15. The optical article of claim 1, wherein the article is an optical element selected from the group consisting of ophthalmic articles, display articles, windows, and mirrors, preferably the ophthalmic article is selected from the group consisting of corrective lenses, non-corrective lenses, contact lenses, and protective lenses.

16. A method of making a heatable optical article, the method comprising:
applying an electrode over at least a portion of a first surface of an optical substrate, wherein applying the electrode comprises:
applying a dispersion comprising an electrically conductive material,
sintering the electrically conductive material to form an electrically conductive three-dimensional network;
applying a photochromic coating comprising at least one photochromic material; and
connecting a power supply to the electrode.

17. The method of claim 16, comprising:
applying the photochromic coating over at least a portion of the first surface and applying the electrode over the photochromic coating; or
applying the electrode over at least a portion of the first surface and applying the photochromic coating over the electrode.

18. The method of claim 16, further comprising:
applying from 2 to 9 layers of the dispersion comprising the electrically conductive material; and
sintering each electrically conductive material layer individually to form the electrically conductive three-dimensional network, or
sintering the 2 to 9 electrically conductive material layers simultaneously to form the electrically conductive three-dimensional network.

19. The method of claim 16, wherein the electrically conductive material comprises conductive wires.

20. The method of claim 19, wherein the conductive nanowires are selected from the group consisting of silver nanowires, nickel nanowires, copper nanowires, and combinations of two or more thereof.

21. The method of claim 16, wherein the electrically conductive material is sintered using electromagnetic radiation.

22. The method of claim 16, wherein applying the electrode further comprises:
applying an electrically conductive encapsulating material adjacent to the electrically conductive three-dimensional network to form an electrically conductive encapsulating layer.

23. The method of claim 22, wherein the electrically conductive encapsulating material is selected from the group consisting of a conductive polymer and a doped metal oxide.

24. The method of claim 16, wherein at least one of the electrically conductive material, the electrically conductive encapsulating material, or the photochromic coating is applied by spin coating.

25. The method of claim 16, further comprising applying one or more coating layers, wherein the one or more coating layers preferably are selected from the group consisting of an adhesive layer, an alignment layer, a primer layer, a hard coat layer, and a barrier layer.
